(19) United States
(12) Patent Application Publication
(10) Pub. No.: US 2005/0202209 A1
(43) Pub. Date: Sep. 15, 2005

(54) Method for producing sheet transport roll, urethane composition used therefor, and sheet transport roll obtained thereby

(75) Inventors: Hirofumi Okuda, Aichi-ken (JP); Satoshi Suzuki, Kasugai-shi (JP); Keita Shiraki, Inuyama-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 11/074,725

(22) Filed: Mar. 9, 2005

(30) Foreign Application Priority Data
Mar. 10, 2004 (JP) JP2004-067757

(51) Int. Cl. B29C 45/14

(52) U.S. Cl. 428/141; 264/279; 264/331.19

(57) ABSTRACT

A method for producing a sheet transport roll with an appropriate cure and short curing time so as to form a textured roll surface without defects caused by air inclusion or the like and thereby obtain a high friction coefficient, and also an excellent abrasion resistance. The method comprises the steps of: providing a mold having an inner textured surface and containing a shaft 1 for the roll; filling a urethane composition into the mold; and forming a urethane roll portion 2 on an outer periphery of the shaft by hardening the urethane composition, the urethane composition comprising: (A) a polyether polyol blend containing polytetramethyleneether glycol (PTMG) and polypropylene glycol (PPG) in a weight ratio of PTMG/PPG=99/1 to 50/50; (B) a polyisocyanate; (C) a chain lengthening agent; (D) a plasticizer; and (E) a diazabicyclo amine salt.

### BACKGROUND OF THE INVENTION

1. Field of the Invention

The present invention relates to a method for producing a sheet transport roll for use in an electrophotographic apparatus such as a copying machine, a printer, a facsimile machine or the like, and to a urethane composition used in the method, and to a sheet transport roll produced thereby.

2. Description of the Art

Sheet transport rolls such as sheet feed rolls and transportation rolls for use in copying machines are generally required to maintain a stable sheet-transporting property for a period of long time. Thus, sheet transport rolls are required to meet various demands such as having a high friction coefficient, high abrasion resistance, a preventive measure against paper dust adhering thereto and the like, so as to be able to hold a sheet of paper securely one by one and then send out the sheet. Recently, from the viewpoint of improving the sheet transporting property along with a high-speed feeding capability, there is the demand that the roll itself be softened. To respond to these demands, the present applicant proposed a urethane roll formed by a polyurethane material into which a specific plasticizer is blended (Japanese Patent Publication No. 2844998). Further, the present applicant proposed a urethane roll comprising a urethane composition in a cured state, having a specific hardness and a specific crosslinking density, prepared from a specific polyether polyol and a polyisocyanate (Japanese Unexamined Patent Publication No. 2002-68515) to satisfy the demands at a higher level. Additionally, the applicant proposed a roll having improved properties in terms of high friction coefficient and having a preventive measure against paper dust adhering in response to the above-mentioned various demands, by means of an improved surface shape of the roll, instead of using an improved composition for forming the roll (Japanese Unexamined Patent Publication No. 2002-120944). In particular, the roll according to Japanese Unexamined Patent Publication No. 2002-120944 is formed by using a mold having an inner textured surface so as to transfer a textured surface from the mold.

However, in the urethane rolls disclosed in the above Japanese Patent Publication No. 2844998 and Japanese Unexamined Patent Publication No. 2002-68515, a curing reaction may occur due to a catalyst remainder contained in a plasticizer. For this reason, the curing time of each material tends to vary widely due to dispersion of the catalyst remainder. As a consequence, it takes a long cure time to obtain a stable cured material because the curing time has to be a long enough time to cure the latest-curing material.

Further, in the sheet transport roll disclosed in the above Japanese Unexamined Patent Publication No. 2002-120944, when pouring the material into the mold, air is easily included in the textured portion of the mold. As a result, there is the problem that air bubbles are contained in the resulting roll.

In view of the foregoing, it is an object of the present invention to provide a method for producing a sheet transport roll with an appropriate cure and short curing time so as to form a textured roll surface without defects caused by air inclusion or the like and to obtain a roll having a high friction coefficient, and having excellent abrasion resistance for maintaining the friction coefficient at a high level. It is another object of the invention to provide a urethane composition used in the method, and to a sheet transport roll produced thereby.

### SUMMARY OF THE INVENTION

In accordance with a first aspect of the present invention to achieve the aforesaid objects, there is provided a method for producing a sheet transport roll, comprising the steps of: providing a mold having an inner textured surface and containing a shaft for the roll; filling a urethane composition into the mold; and forming a urethane roll portion on an outer periphery of the shaft by curing the urethane composition, the urethane composition comprising: (A) a polyether polyol blend containing polytetramethyleneether glycol (PTMG) and polypropylene glycol (PPG) in a weight ratio of PTMG/PPG=99/1 to 50/50; (B) a polyisocyanate; (C) a chain lengthening agent; (D) a plasticizer; and (E) a diazabicyclo amine salt, wherein the component (D) is present at 5 to 50 parts by weight based upon 100 parts by weight of the total amount of a urethane prepolymer comprising the components (A) and (B).

In accordance with a second aspect of the present invention, there is provided a urethane composition for a sheet transport roll, comprising the above-mentioned components (A) to (E), wherein the component (D) is present at 5 to 50 parts by weight based upon 100 parts by weight of the total amount of a urethane prepolymer comprising the components (A) and (B).

In accordance with a third aspect of the present invention, there is provided a sheet transport roll having a textured roll surface comprising a shaft and a urethane roll portion provided on an outer periphery of the shaft, the urethane roll portion formed by a urethane composition comprising the above-mentioned components (A) to (E), wherein the component (D) is present at 5 to 50 parts by weight based upon 100 parts by weight of the total amount of a urethane prepolymer comprising the components (A) and (B).

The inventors of the present invention conducted intensive studies on the correlation between the materials for forming a roll portion and the roll surface shape, so as to provide a sheet transport roll by an appropriate cure and short curing time having a textured roll surface without defects caused by air inclusion or the like which has a high friction coefficient, and also has excellent abrasion resistance. As a result, the inventors found that, when using a mold having an inner textured surface and materials are filled into the mold for forming a roll portion, and when a urethane composition containing a specific amount of plasticizer and a diazabicyclo amine salt as a catalyst is used, the viscosity increase of materials filled therein can be restricted by the action of the catalyst until the temperature of the mold has increased. As a consequence, materials can spread into every corner of the mold and air inclusion can be prevented, or air can be easily released even if air is included. Further, the inventors found that the curing time can be shortened because curing reaction rapidly proceeds with temperature increase of the mold by means of the effect of the catalyst. Thus, the present invention has been attained.

The term “sheet transport roll” herein means a roll having a sheet transport capability, such as a sheet feed roll (such as a pick-up roll, a feed roll or a retard roll) as well as a sheet transport roll.

As described above, the present invention relates to a method for producing a sheet transport roll, comprising the steps of providing a mold having an inner textured surface and containing a shaft for the roll, filling a urethane composition containing a plasticizer (component (D)) at a specific blend ratio and a specific catalyst (component (E)) into the mold and forming a urethane roll portion on an outer periphery of the shaft by curing the urethane composition. As a result, the method of the present invention can prevent air-bubble formation on a roll surface due to air inclusion when filling the urethane composition into the mold and also can shorten curing time. Further, the sheet transport roll of the present invention has a high friction coefficient, which can be maintained for a long time, and thus has excellent abrasion resistance.

When the surface roughness (Rz) of the inner textured surface formed on the mold is within a specific range, the friction coefficient of the resulting roll more effectively can be maintained, resulting in an excellent sheet transporting property.

### BRIEF DESCRIPTION OF THE DRAWING

FIG. 1 is a perspective view illustrating an exemplary sheet transport roll according to the present invention; and

FIG. 2 is an enlarged sectional view partially illustrating the surface configuration of a mold for use in a method for producing a sheet transport roll according to the present invention.

### DETAILED DESCRIPTION OF THE INVENTION

The present invention will hereinafter be described by way of embodiments thereof.

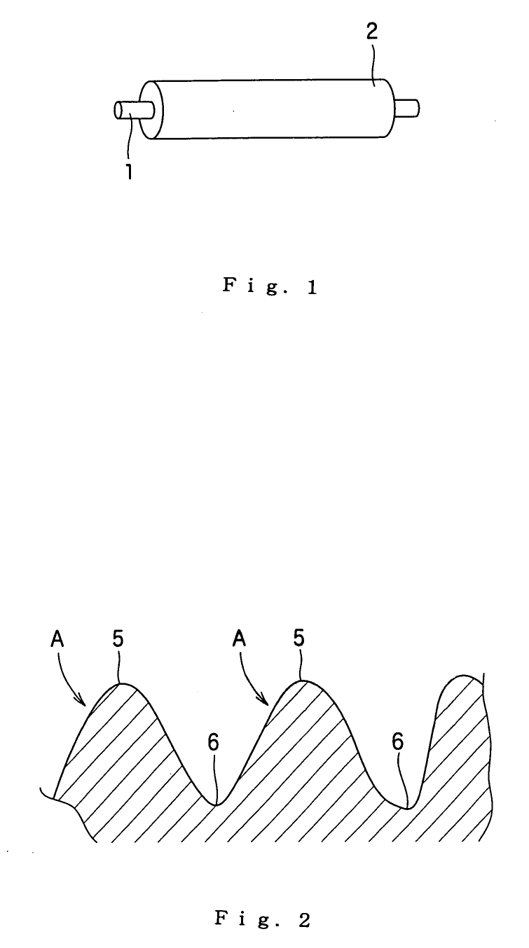

A sheet transport roll according to the present invention may have a construction as shown in FIG. 1 where a urethane roll portion 2 composed of a specific urethane composition is provided on an outer periphery of a shaft 1. According to the present invention, the urethane roll portion 2 of the sheet transport roll may be formed by using a mold having an inner textured surface so that the textured surface is transferred from the mold to the urethane roll portion 2 formed by a urethane composition containing a specific amount of a plasticizer and a specific catalyst, a characteristic feature of the present invention. Thereby, the surface of a roll can be formed into a desired textured surface by using the above-mentioned specific mold without causing defects due to air inclusion or the like when filling the urethane composition into the mold, and thus the resulting roll has a high friction coefficient and excellent abrasion resistance.

The construction of the shaft 1 is not particularly limited, but examples thereof include a solid shaft and a hollow cylindrical shaft. Exemplary materials for the shaft 1 include materials such as stainless steels, aluminum and plated iron. Further, a shaft made of resins such as polyacetal, polyamide or polyethylene terephthalate may be used.

A urethane composition for forming the urethane roll portion 2 is prepared by blending a specific polyether polyol blend (component (A)), a polyisocyanate (component (B)), a chain lengthening agent (component (C)), a plasticizer (component (D)) and a specific catalyst (component (E)).

The specific polyether polyol blend (component (A)) is prepared by blending polytetramethyleneether glycol (PTMG) and polypropylene glycol (PPG) in a predetermined weight ratio.

The weight ratio between polytetramethyleneether glycol (PTMG) and polypropylene glycol (PPG) is in the range of PTMG/PPG=99/1 to 50/50, preferably PTMG/PPG=90/10 to 60/40. If the weight of PPG in the ratio 99/1 is smaller than 1, it generally is not be possible to provide a sufficiently high friction coefficient. If the weight of PPG in the ratio 50/50 is greater than 50, the abrasion resistance tends to deteriorate.

The polytetramethyleneether glycol (PTMG) typically has a number average molecular weight (Mn) of 1000 to 3000, preferably 1500 to 2500. The polypropylene glycol (PPG) typically has a number average molecular weight (Mn) of 1000 to 3000, preferably 1500 to 2500.

The polyisocyanate (component (B)) to be employed along with the polyether polyol blend (component (A)) is not particularly limited, but may be selected from any of those polyisocyanates typically used for preparation of common urethane compositions. Examples of suitable polyisocyanates include diisocyanates such as 4,4′-diphenylmethane diisocyanate (MDI), 2,4-tolylene diisocyanate (2,4-TDI), 2,6-tolylene diisocyanate (2,6-TDI), 3,3′-bitolylene-4,4′-diisocyanate, 3,3′-dimethyldiphenylmethane-4,4′-diisocyanate, 2,4 -tolylene diisocyanate uretidinedione (dimer of 2,4-TDI), 1,5-naphthylene diisocyanate, m-phenylene diisocyanate, hexamethylene diisocyanate, isophorone diisocyanate (IPDI), 4,4′-dicyclohexylmethane diisocyanate (hydrogenated MDI), carbodiimide-modified MDI, o-toluidine diisocyanate, xylene diisocyanate, p-phenylene diisocyanate and lysine diisocyanate methyl ester; triisocyanates such as triphenylmethane-4,4′,4″-triisocyanate; and polymeric MDI. These polyisocyanates may be used either alone or in combination. Among these polyisocyanates, 2,4-TDI and MDI are particularly preferred in terms of the resultant abrasion resistance for the urethane composition.

The ratio between the number of moles (a) of hydroxyl groups in the polyether polyol blend (component (A)) and the number of moles (b) of isocyanate groups in the polyisocyanate (component (B)) is preferably a/b=1.0/1.5 to 1.0/3.5.

The chain lengthening agent (component (C)) to be employed along with the polyether polyol blend (component (A)) and the polyisocyanate (component (B)) is not particularly limited, but may be selected from any of those agents typically employed for the preparation of common urethane compositions. Examples of the chain lengthening agent include polyols such as 1,4-butanediol (1,4-BD), ethylene glycol, diethylene glycol, propylene glycol, dipropylene glycol, hexanediol, 1,4-cyclohexanediol, 1,4-cyclohexanedimethanol, xylene glycol, triethylene glycol, trimethylolpropane (TMP), glycerol, pentaerythritol, sorbitol and 1,2,6-hexanetriol, which have molecular weights of not higher than 300. These may be used either alone or in combination. Among these chain lengthening agents, 1,4-butanediol (1,4-BD) and trimethylolpropane (TMP) are particularly preferred in terms of the resultant abrasion resistance and compression resistance for the urethane composition.

The chain lengthening agent (component (C)) is blended in the urethane composition, preferably in a proportion such that the ratio between the number of moles (u) of isocyanate groups in a specific urethane prepolymer containing the specific polyether polyol blend (component (A)) and the polyisocyanate (component (B)) (hereinafter referred to simply as “urethane prepolymer”) and the number of moles (c) of hydroxyl groups in the chain lengthening agent (component (C)) is u/c=100/75 to 100/105, particularly preferably u/c=100/85 to 100/95. If the number of moles (c) of the hydroxyl groups in the chain lengthening agent (component (C)) is smaller than 75 relative to the ratio 100/75, the resulting urethane composition tends to have an extremely high hardness and a reduced friction coefficient. If the number of moles (c) of the hydroxyl groups in the chain lengthening agent (component (C)) is greater than 105 relative to the ratio 100/105, the resulting urethane composition tends to have a reduced crosslinking density and deteriorated abrasion resistance.

Examples of the plasticizer (component (D)) to be employed along with components (A) to (C) discussed above include phthalic acid derivatives such as dioctyl phthalate (DOP): sebacic acid derivatives such as dioctyl sebacate (DOS): adipic acid derivatives such as dibutyl diglycol adipate (BXA) and dibutyl carbitol adipate: phosphoric acid derivatives such as tributyl phosphate (TBP), tributoxyethyl phosphate (TBXP), trioctyl phosphate (TOP) and triphenyl phosphate (TPP): polyester derivatives, polyether ester derivatives, polyether derivatives. These plasticizers may be used either alone or in combination. Among these plasticizers, polyether ester derivatives are preferred in terms of compatibility with the other components and retention of the high friction coefficient for the urethane composition.

The blending ratio of the plasticizer (component (D)) may preferably be within the range of 5 to 50 parts by weight (hereinafter just abbreviated to “parts”) based upon 100 parts of the urethane prepolymer, particularly preferably 10 to 50 parts. When this blending ratio is less than 5 parts, intended high friction coefficient and abrasion resistance may not be obtained. When the blending ratio is over 50 parts, the plasticizer tends to bleed onto the roll surface and thereby contaminate the surface.

The diazabicyclo amine salt (component (E)), which is blended along with the components (A) to (D) in the urethane composition, is another feature of the present invention. According to the studies of the inventors of the present invention, this diazabicyclo amine salt (component (E)) is thought to act as a catalyst for the curing reaction. Examples of diazabicyclo amines suitable for the salt include 1,8-diazabicyclo[5.4.0]undecene-7 (DBU) and 1,5-diazabicyclo[4.3.0]nonene-5 (DBN). Examples of the compound for forming the salt of the diazabicyclo amine include phenol, formic acid, octyl acid, oleic acid, acetic acid, maleic acid and boric acid. These diazabicyclo amine salts may be used either alone or in combination. Among them, a DBU phenoxide and a DBU formate are particularly preferred in terms of the resultant flow properties of the material and providing short-time curing.

In the present invention, additional catalysts may be added along with the diazabicyclo amine salt (component (E)) as long as the effects such as shortening curing time may not be prohibited. Examples of the additional catalysts include triethylene diamine, 2-methyl imidazole, DBU and DBN, which may be used either alone or in combination. When using an additional catalyst along with the diazabicyclo amine salt (component (E)), it is preferred that the blending ratio of the additional catalyst is not more than 50% by weight based upon the total amount of the catalyst and the salt.

The blending ratio of the diazabicyclo amine salt (component (E)) is preferably within the range of 0.01 to 0.08 parts by weight based upon 100 parts of the urethane prepolymer, particularly preferably 0.02 to 0.06 parts. When the blending ratio is less than 0.01 parts, shortening of the curing time of the urethane composition tends to become difficult. When the blending ratio is over 0.08 parts, curing tends to proceed before completion of pouring of the urethane composition into the mold.

The materials for forming the urethane roll portion 2 of the sheet transport roll according to the present invention may appropriately contain one or more additives such as an ion conductive agent, a hollow filler and/or the like, in addition to the components (A) to (E).

The ion conductive agent may act as an antistatic agent so as to help prevent paper dust from adhering to the roll. Examples of the ion conductive agent include ammonium salts such as perchlorates, chlorates, hydrochlorides, bromates, iodates, borofluorates, sulfates, alkylsulfates, carboxylates and sulfonates of tetraethyl ammonium, tetrabutyl ammonium, dodecyltrimethyl ammonium (lauryltrimethyl ammonium and the like), octadecyltrimethyl ammonium (stearyltrimethyl ammonium and the like), hexadecyltrimethyl ammonium, benzyltrimethyl ammonium and modified aliphatic dimethylethyl ammonium; and perchlorates, chlorates, hydrochlorides, bromates, iodates, borofluorates, trifluoromethylsulfates and sulfonates of alkali metals and alkaline earth metals such as lithium, sodium, calcium and magnesium. These ion conductive agents may be used either alone or in combination. Among these ion conductive agents, quaternary ammonium salts of alkylsulfates and quaternary ammonium salts of polybasic carboxylates are particularly preferred because any increase in electric resistance thereof during continuous energization is relatively small. Boric acid ester compounds may also be used as the ion conductive agent.

The ion conductive agent is appropriately blended, as desired. The ion conductive agent preferably is blended in a proportion of not greater than 3 parts by weight, particularly preferably 0.1 to 3 parts, based on 100 parts of the urethane prepolymer.

Examples of the hollow filler which may be employed in the compositions of the present invention include micro-capsules and micro-balloons. Exemplary micro-balloons include inorganic micro-baloons such as glass micro-balloons, silica micro-balloons, carbon micro-balloons, alumina micro-balloons, zirconia micro-balloons and volcanic ash micro-balloons, and polymeric micro-balloons such as phenol resin micro-balloons, vinylidene chloride resin micro-balloons and elastic micro-balloons of thermoplastic resins such as polymers of vinylidene chloride, acrylonitrile, methacrylonitrile, acrylic ester and methacrylic acid ester and copolymers of any of these thermoplastic resins. Among these micro-balloons, elastic micro-balloons are preferred. The hollow filler typically has an average particle diameter of 5 to 200 μm, preferably 15 to 120 μm.

The hollow filler is appropriately blended, as disired. The hollow filler is typically blended in a proportion of 1 to 10 parts, preferably 2 to 5 parts, based on 100 parts of the urethane prepolymer.

In addition to the aforesaid components, one or more of a foaming agent, a surface active agent, a flame retardant, a coloring agent, a filler, a stabilizer, a release agent and the like may optionally be added to the material for forming the urethane portion 2 of the sheet transport roll according to the present invention.

The urethane composition of the material for forming the urethane portion 2 of the sheet transport roll according to the present invention (hereinafter just abbreviated to “urethane composition”) is prepared, for example, in the following manner. The polyether polyol blend (component (A)) containing PTMG and PPG in the predetermined weight ratio is degassed and dehydrated in vacuo under predetermined conditions (preferably at 80° C. for one hour). In turn, the resulting polyether polyol blend is mixed and reacted with the polyisocyanate (component (B)) in a nitrogen atmosphere under predetermined conditions (preferably at 80° C. for three hours) for preparation of the urethane prepolymer which has NCO groups at terminals thereof. Then, the plasticizer (component (D)) and the diazabicyclo amine salt (component (E)) are blended with the urethane prepolymer, and further the chain lengthening agent (component (C)) is blended therewith, whereby the intended urethane composition is provided.

As a method for the preparation of the urethane composition, a prepolymerization method like the above-mentioned above, is preferred in which polyol and isocyanate are preliminarily reacted for producing the prepolymer having NCO groups at terminals thereof, and then the other components are added thereto, and the resulting product is heated for curing, as required. However, the preparation method is not limited thereto. For example, a “one-shot process” may be employed in which all the components are mixed together at one time and then cured, or a “semi-one-shot process” may be employed in which the polyether polyol blend (component (A)) is preliminarily separated into a polyol (A1) and another polyol (A2), for example, at a weight ratio of 1:1, and the polyol (A1) and the polyisocyanate (component (B)) are reacted for producing a prepolymer, and then the polyol (A2) and the chain lengthening agent (component (C)) are reacted with the prepolymer.

The sheet transport roll is produced, for example, in the following manner. A mold wherein an inner surface is textured is prepared and the shaft 1 is set therein. In turn, the urethane composition preferably prepared in one of the aforesaid manners is filled into the mold, and heated up to a predetermined temperature (preferably 140° C.), and then allowed to undergo a curing reaction under predetermined conditions (preferably at 140° C. for 30 minutes). Then, the resulting cured body formed from the urethane composition is released from the mold, and subjected to a secondary curing process under predetermined conditions (preferably at 110° C. for 12 hours). Thus, a sheet transport roll is produced, which has the urethane roll portion 2 provided on the outer periphery of the shaft 1, as shown in FIG. 1. In the above-mentioned production method, the urethane composition may be poured into the mold when the urethane composition is filled. However, the method is not limited thereto and, for example, may include an injection filling method.

Thus, according to the present invention, the inner surface (or inner peripheral wall) of the mold used for producing the sheet transport roll is textured. The inner surface of the mold may be a textured surface “A” composed of peaks 5 and valleys 6 all over the surface, as shown in FIG. 2. Examples of methods for imparting such a textured surface to the mold may include, for example, an electrical discharging method, a shot blast method and a chemical processing method.

Preferably, the inner surface of the mold has preferably a surface roughness of Rz 10-70 μm, particularly preferably 30-50 μm. When the surface roughness (Rz) is less than 10 μm, the sheet transport property tends to deteriorate because it is difficult to form sufficient roughness on the roll surface. When the surface roughness (Rz) is over 70 μm, tip ends of convex portions on the roll surface transferred from the mold tend to be easily abraded in use so that it is difficult to maintain the sheet transport property initially available. The surface roughness (Rz) is measured in accordance with Japanese Industrial Standards (hereinafter just abbreviated to “JIS”) B 0601 (1994) by means of a SURFCOM surface roughness meter available from Tokyo Seimitsu Co., Ltd. The ten-point mean roughness (Rz) is the difference between the average of the five highest peaks from to the mean line and the average depth to the five deepest valleys from the mean line of a surface roughness curve.

In the urethane roll portion 2 of the sheet transport roll obtained by using a mold having an inner textured surface has a textured roll surface as transferred from the mold, in detail, each peak and each valley have a multiplicity of fine projections. Therefore, the urethane roll portion 2 preferably has a surface roughness (Rz) of 10 to 70 μm like the mold surface.

The urethane roll portion 2 of the thus obtained sheet transport roll preferably has a thickness of 1 to 8 mm, more preferably 3 to 6 mm.

The structure of the sheet transport roll according to the present invention is described as a single-layer structure having a urethane roll portion 2 formed on an outer periphery of a shaft 1. However, the structure is not limited thereto. For example, a thin layer may be formed on an outer periphery of the urethane roll portion 2 of the sheet transport roll according to the present invention as long as a textured surface of the urethane roll portion 2 remains effective.

Next, an explanation will be given for Examples of the present invention and for Comparative Examples.

Urethane Prepolymers (A) to (E)

Urethane prepolymers (A) to (E) employed in Examples were each prepared in the following manner. First, polyether polyol blends each containing PTMG and PPG in a proportion shown in Table 1 were degassed and dehydrated in vacuo at 80° C. for one hour. Then, the resulting polyether polyol blends were each mixed with a polyisocyanate in a proportion shown in Table 1 and reacted in a nitrogen atmosphere at 80° C. for three hours. Thus, urethane prepolymers were prepared which each had NCO groups at terminals thereof.

TABLE 1
(parts)

| Urethane prepolymer | | | | |
|---|---|---|---|---|
| A | B | C | D | E |

Polyether polyol blend

| | | | | | |
|---|---|---|---|---|---|
| PTMG*¹ | 75 | 90 | 60 | 99 | 50 |
| PPG*² | 25 | 10 | 40 | 1 | 50 |

Polyisocyanate

| | | | | | |
|---|---|---|---|---|---|
| 2,4-TDI | 21 | 21 | 21 | 21 | 21 |

*¹Mn = 2000
*²Mn = 2000

Molds for Forming Rolls

Molds (a) to (f) employed in Examples and Comparative Examples were each prepared in the following manner such that each mold has the surface roughness (Rz) as shown in Table 2. Molds (a) to (c) were each processed by an electrical discharging method such that the surface roughness (Rz) was 8 μm, 10 μm and 30 μm, respectively. Molds (d) to (f) were each processed by a chemical processing method followed by a shot blast method such that the surface roughness (Rz) was 50 μm, 70 μm and 80 μm, respectively. The surface roughness was measured in accordance with JIS B 0601 (1994) by means of a SURFCOM surface roughness meter available from Tokyo Seimitsu Co., Ltd. The ten-point mean roughness (Rz) is the difference between the average of the five highest peaks from to the mean line and the average depth to the five deepest valleys from the mean line of a surface roughness curve.

TABLE 2

| | Mold | | | | | |
|---|---|---|---|---|---|---|
| | a | b | c | d | e | f |
| Surface roughness (Rz) | 8 | 10 | 30 | 50 | 70 | 80 |

| | | |
|---|---|---|
| Processing method | Electrical | Chemical processing |
| | discharging method | method and a shot |
| | | blast method |

### EXAMPLE 1

The urethane prepolymer (A) was degassed in vacuo at 90° C. for 30 minutes, and 30 parts of a polyether ester plasticizer (RS-700 available from ASAHI DENKA CO., LTD. of Tokyo, Japan) and 0.04 parts of a DBU phenoxide as a catalyst were mixed with 100 parts of the urethane prepolymer. Further, 2.8 parts of 1,4-butanediol (1,4-BD) and 1.9 parts of trimethylolpropane (TMP) were added thereto and then the resulting mixture was mixed under a reduced pressure for 2 minutes. Thus, the materials for producing urethane roll portions were prepared.

### EXAMPLES 2 TO 13 AND COMPARATIVE EXAMPLES 1 to 5

Materials for producing urethane roll portions of Examples 2 to 13 and Comparative Examples 1 to 5 were produced in substantially the same manner as in Example 1, except that the urethane compositions each contained ingredients in the proportions as shown in Tables 3 to 5.

The sheet transport rolls were produced by using the thus obtained materials for producing urethane roll portions. Molds for the sheet transport roll as shown in Tables 3 to 5 were each provided with a shaft made of stainless steel (SUS304) and having a diameter of 10 mm set therein, and then heated up to 140° C. The resulting mixture was poured into the mold, and allowed to undergo a curing reaction at 140° C. for predetermined time (10 minutes or 20 minutes). In turn, the resulting cured body was unmolded, and subjected to a secondary curing process at 110° C. for 12 hours. Thus, a sheet transport roll was produced which had a urethane roll portion (having a thickness of 5 mm) provided on the outer periphery of the shaft.

The sheet transport rolls of Examples 1 to 13 and Comparative Examples 1 to 5 thus produced were evaluated on the following criteria. The results are shown in Tables 3 to 5.

Curing Property

The hardening state of each of the sheet transport rolls was visually observed after each time lapse of 10 minutes and 20 minutes. In Tables 3 to 5, a symbol X indicates that the unmolded material was not hardened after each time lapse and a symbol ◯ indicates that the unmolded material was hardened after each time lapse.

Air Inclusion

In Tables 3 to 5, a symbol X indicates that 5 or more air bubbles were formed, by air included with materials poured into the mold, on a surface of the sheet transport roll, a symbol Δ indicates that 1 to 4 air bubbles were formed, and a symbol ◯ indicates that a good roll surface was formed without air bubbles.

Hardness

The surface hardness of each of the sheet transport rolls was measured with a load of 9.8 N by means of a durometer of Type A in accordance with JIS K 6253.

Friction Coefficient

The sheet transport rolls were each incorporated as a transport roll in a commercially available copying machine, and a sheet feed and transport durability test was performed. For each of the sheet transport rolls, the friction coefficient was measured, initially and after transportation of 500,000 paper sheets (after durability test), at a circumferential speed of 200 mm/sec with a load of 2.9 N by means of a tester having a greater sheet curvature radius.

Abrasion Amount

For each of the sheet transport rolls, the diameter of a longitudinally middle portion thereof was measured by means of a laser scan micrometer initially and after transportation of 500,000 paper sheets (after durability test), and the difference between the diameters thus measured was determined as an abrasion amount.

Transportation Ability

The sheet transport rolls were each incorporated as a transport roll in a commercially available copying machine, and evaluated for transportation ability. In Tables 3 to 5, a symbol ◯ indicates that neither sheet transportation failure nor overlapped sheet transportation occurred during transportation of 500,000 paper sheets, a symbol Δ indicates that sheet transportation failure or overlapped sheet transportation occurred during transportation of not less than 400,000 and less than 500,000 paper sheets, and a symbol X indicates that sheet transportation failure or overlapped sheet transportation occurred during transportation of less than 400,000 paper sheets.

TABLE 3
(parts)

| | Example | | | | | | |
|---|---|---|---|---|---|---|---|
| | 1 | 2 | 3 | 4 | 5 | 6 | 7 |
| Mold | c | d | d | c | c | c | d |
| Urethane prepolymer | 100 | 100 | 100 | 100 | 100 | 100 | 100 |
| (Type) | A | B | C | D | E | A | B |

Plasticizer

| | | | | | | | |
|---|---|---|---|---|---|---|---|
| RS-700 | 30 | 30 | 40 | — | — | 5.0 | 10 |
| RS-705*¹ | — | — | — | 50 | 30 | — | — |

Chain lengthening agent

| | | | | | | | |
|---|---|---|---|---|---|---|---|
| 1,4-BD | 2.8 | 2.8 | 2.8 | 2.8 | 2.8 | 2.8 | 2.8 |
| TMP | 1.9 | 1.9 | 1.9 | 1.9 | 1.9 | 1.9 | 1.9 |

Catalyst

| | | | | | | | |
|---|---|---|---|---|---|---|---|
| TEDA | — | — | 0.01 | — | — | — | — |
| DBU phenoxide | 0.04 | — | 0.04 | — | — | 0.03 | 0.03 |
| DBU formate | — | 0.02 | — | 0.02 | 0.02 | 0.01 | 0.01 |

Curing property

| | | | | | | | |
|---|---|---|---|---|---|---|---|
| 10 minutes | ◯ | ◯ | ◯ | ◯ | ◯ | ◯ | ◯ |
| 20 minutes | — | — | — | — | — | — | — |
| Air inclusion | ◯ | ◯ | ◯ | ◯ | ◯ | ◯ | ◯ |
| Hardness (°) | 45 | 44 | 40 | 37 | 45 | 58 | 53 |
| Initial friction | 1.9 | 1.9 | 2.0 | 1.9 | 2.1 | 1.9 | 1.9 |
| coefficient | | | | | | | |
| Friction coefficient | 1.9 | 1.9 | 2.0 | 1.9 | 2.1 | 1.9 | 1.9 |
| after durability test | | | | | | | |
| Abrasion amount (μm) | 280 | 250 | 400 | 500 | 300 | 200 | 220 |
| Transportation ability | ◯ | ◯ | ◯ | ◯ | ◯ | ◯ | ◯ |

*¹Polyether plasticizer available from ASAHI DENKA CO., LTD. of Tokyo, Japan

TABLE 4
(parts)

| | Example | | | | | |
|---|---|---|---|---|---|---|
| | 8 | 9 | 10 | 11 | 12 | 13 |
| Mold | c | c | b | e | a | f |
| Urethane | 100 | 100 | 100 | 100 | 100 | 100 |
| prepolymer | | | | | | |
| (Type) | A | A | A | A | A | A |

Plasticizer

| | | | | | | |
|---|---|---|---|---|---|---|
| RS-700 | 30 | 30 | 30 | 30 | 30 | 30 |
| RS-705*¹ | — | — | — | — | — | — |

Chain lengthening agent

| | | | | | | |
|---|---|---|---|---|---|---|
| 1,4-BD | 2.8 | 2.8 | 2.8 | 2.8 | 2.8 | 2.8 |
| TMP | 1.9 | 1.9 | 1.9 | 1.9 | 1.9 | 1.9 |

Catalyst

| | | | | | | |
|---|---|---|---|---|---|---|
| TEDA | — | — | — | — | — | — |
| DBU phenoxide | 0.01 | 0.1 | 0.04 | 0.04 | 0.04 | 0.04 |
| DBU formate | — | — | — | — | — | — |

Curing property

| | | | | | | |
|---|---|---|---|---|---|---|
| 10 minutes | ◯ | ◯ | ◯ | ◯ | ◯ | ◯ |
| 20 minutes | — | — | — | — | — | — |
| Air inclusion | ◯ | ◯ | ◯ | ◯ | ◯ | Δ |
| Hardness (°) | 43 | 47 | 44 | 45 | 45 | 44 |
| Initial friction | 2.0 | 2.0 | 1.9 | 1.9 | 1.6 | 2.2 |
| coefficient | | | | | | |
| Friction | 1.9 | 1.9 | 1.9 | 1.8 | 1.2 | 2.0 |
| coefficient | | | | | | |
| after durability | | | | | | |
| test | | | | | | |
| Abrasion | 350 | 250 | 300 | 300 | 290 | 270 |
| amount (μm) | | | | | | |
| Transportation | ◯ | ◯ | ◯ | ◯ | Δ | ◯ |
| ability | | | | | | |

*¹Polyether plasticizer available from ASAHI DENKA CO., LTD. of Tokyo, Japan

TABLE 5
(parts)

| | Comparative Example | | | | |
|---|---|---|---|---|---|
| | 1 | 2 | 3 | 4 | 5 |
| Mold | c | c | c | d | d |
| Urethane prepolymer | 100 | 100 | 100 | 100 | 100 |
| (Type) | A | B | C | A | A |

Plasticizer

| | | | | | |
|---|---|---|---|---|---|
| RS-700 | 30 | 30 | 40 | 3 | 60 |
| RS-705*¹ | — | — | — | — | — |

Chain lengthening agent

| | | | | | |
|---|---|---|---|---|---|
| 1,4-BD | 2.8 | 2.8 | 2.8 | 2.8 | 2.8 |
| TMP | 1.9 | 1.9 | 1.9 | 1.9 | 1.9 |

Catalyst

| | | | | | |
|---|---|---|---|---|---|
| TEDA | 0.05 | 0.1 | 0.1 | — | — |
| DBU phenoxide | — | — | — | 0.04 | 0.04 |
| DBU formate | — | — | — | — | — |

Curing property

| | | | | | |
|---|---|---|---|---|---|
| 10 minutes | X | X | X | ◯ | ◯ |
| 20 minutes | X | ◯ | ◯ | — | — |
| Air inclusion | X | X | X | ◯ | ◯ |
| Hardness (°) | 44 | 45 | 41 | 61 | 32 |
| Initial friction coefficient | 1.9 | 1.9 | 2.0 | 2.4 | 1.8 |
| Friction coefficient | 1.9 | 1.9 | 2.0 | 1.2 | 1.7 |
| after durability test | | | | | |
| Abrasion amount (μm) | 310 | 330 | 390 | 220 | 900 |
| Transportation ability | X | X | X | X | X |

*¹Polyether plasticizer available from ASAHI DENKA CO., LTD. of Tokyo, Japan

As can be understood from the above results, the sheet transport rolls of Examples 1 to 13 each had satisfactory hardness, a high friction coefficient and small abrasion amount, and thus had excellent durability, and had a satisfactory transportation ability. Since the surface roughness (Rz) of the mold used for forming the sheet transport roll of Example 12 was 8, the obtained sheet transport roll had lower friction coefficient than those of the other Examples, and thus had slightly deteriorated transportation ability.

To the contrary, the sheet transport roll of Comparative Example 1 was not cured in 20 minutes, because only a catalyst of triethylene diamine (TEDA) was used. Also, air bubbles caused by air inclusion were identified in the sheet transport roll of Comparative Example 1. Since each blending amount of triethylene diamine (TEDA) was increased for Comparative Examples 2 and 3 as compared with that of Comparative Example 1, the mold was cured in 20 minutes. However, air bubbles caused by air inclusion were identified. Since the blending amount of a plasticizer of Comparative Example 4 was 3 parts and thus too low, paper dust easily adhered to the roll thereof, resulting in deterioration of coefficient friction. Since the blending amount of a plasticizer of Comparative Example 5 was 60 parts and thus too high, the strength was drastically deteriorated, so that abrasion resistance originated from urethane was damaged.

The sheet transport roll according to the present invention is advantageously employed in sheet transport rolls such as a sheet feed roll, a transport roll and the like for an electrophotographic apparatus, and may be employed as a sheet transport belt and a sheet transport roll for a vending machine, an automatic ticket checker, an automatic teller machine, a money changing machine, a counting machine and a cash dispenser.

1. A method for producing a sheet transport roll, comprising the steps of: providing a mold having an inner textured surface and containing a shaft for the roll; filling a urethane composition into the mold; and forming a urethane roll portion on an outer periphery of the shaft by curing the urethane composition filled into the mold, the urethane composition comprising: (A) a polyether polyol blend containing polytetramethyleneether glycol (PTMG) and polypropylene glycol (PPG) in a weight ratio of PTMG/PPG=99/1 to 50/50; (B) a polyisocyanate; (C) a chain lengthening agent; (D) a plasticizer; and (E) a diazabicyclo amine salt, wherein the component (D) is present at 5 to 50 parts by weight based upon 100 parts by weight of the total amount of a urethane prepolymer comprising the components (A) and (B).

2. A method as set forth in claim 1, wherein surface roughness (Rz) of the inner textured surface of the mold is 10 to 70 μm.

3. A urethane composition comprising: (A) a polyether polyol blend containing polytetramethyleneether glycol (PTMG) and polypropylene glycol (PPG) in a weight ratio of PTMG/PPG=99/1 to 50/50; (B) a polyisocyanate; (C) a chain lengthening agent; (D) a plasticizer; and (E) a diazabicyclo amine salt, wherein the component (D) is present at 5 to 50 parts by weight based upon 100 parts by weight of the total amount of a urethane prepolymer comprising the components (A) and (B).

4. A sheet transport roll having a textured roll surface comprising: a shaft; and a urethane roll portion provided on an outer periphery of the shaft, the urethane roll portion formed from a urethane composition comprising: (A) a polyether polyol blend containing polytetramethyleneether glycol (PTMG) and polypropylene glycol (PPG) in a weight ratio of PTMG/PPG=99/1 to 50/50; (B) a polyisocyanate; (C) a chain lengthening agent; (D) a plasticizer; and (E) a diazabicyclo amine salt, wherein the component (D) is present at 5 to 50 parts by weight based upon 100 parts by weight of the total amount of a urethane prepolymer comprising the components (A) and (B).

5. A sheet transport roll as set forth in claim 4, wherein the surface roughness (Rz) of the textured roll surface is 10 to 70 μm.
